(19) United States
(12) Patent Application Publication
(10) Pub. No.: US 2017/0161743 A1
(43) Pub. Date: Jun. 8, 2017

(54) USE OF ENCRYPTION TO PROVIDE SECURE CREDIT CARD PAYMENTS

(71) Applicant: Empire Technology Development LLC, Wilmington, DE (US)

(72) Inventors: Yehuda BINDER, Hod-Hasharon (IL); Ehud SPIEGEL, Petach Tikva (IL); Shmuel UR, Galil (IL); Vlad Grigore DABIJA, Mountain View, CA (US)

(21) Appl. No.: 14/787,849

(22) PCT Filed: Dec. 16, 2014
(86) PCT No.: PCT/US14/70680

§ 371 Date: Oct. 29, 2015

(51) Int. Cl. G06Q 20/40; G06Q 20/24; G06Q 20/38

(52) U.S. Cl. CPC G06Q 20/409; G06Q 20/3829; G06Q 20/24; G06Q 20/4016; G06Q 2220/00

(57) ABSTRACT

Technologies are generally described that relate to facilitating the use of encryption to secure credit card payments. An example method may include receiving, by a device including a processor, over a wired or wireless channel, first credit card information to process a transaction, wherein the first credit card information is determined to be associated with a first entity. The method may also include generating second credit card information based on an encryption of the first credit card information using an encryption key of encryption keys, wherein the encryption key is indicative of an identity of a second entity to which the second credit card information is to be presented. The method may also include initiating transmission, over the wired or wireless channel, of the second credit card information to the second entity for consummation of the transaction.

### TECHNICAL FIELD

The subject disclosure relates generally to facilitating the use of encryption to provide secure credit card payments.

### BACKGROUND

Unless otherwise indicated herein, the materials described in this section are not prior art to the claims in this application and are not admitted to be prior art by inclusion of this section.

An impediment to transactions is the lack of security inherent in providing credit card information to a merchant. In particular, many consumers dislike providing credit card numbers to merchants. Specifically, furnishing a credit card number may render a consumer vulnerable to theft through the improper use of the stolen credit card number by the merchant or by an employee of the merchant. In many cases, the consumer may then incur the inconvenience of needing to secure police reports, waiting for re-issued new credit cards and/or proving that the transactions that result from stolen the credit card number were not authorized.

Yet, a credit card number, along with other details, is often to be provided to merchants to finalize the transaction. Specifically, the credit card number and other information are often utilized by merchants to obtain authorization for payment of the products and/or services being purchased. This scenario is pervasive whether a consumer is making a purchase in a restaurant, at a gas station, on the internet or with a street merchant. The risk of credit card number theft exists in each of these scenarios.

The above-described issues hamper the use of credit cards for transactions and thereby may limit consumer spending and/or increase the risk of consumer fraud.

### SUMMARY

In various, non-limiting embodiments, systems, devices, methods and/or computer-readable storage media that facilitate the use of encryption to provide secure credit card payments are described herein.

In some embodiments, a method may include receiving, by a device including a processor, over a wired or wireless channel, first credit card information to process a transaction, wherein the first credit card information is determined to be associated with a first entity. The method may also include generating second credit card information based on an encryption of the first credit card information using an encryption key of encryption keys, wherein the encryption key is indicative of an identity of a second entity to which the second credit card information is to be presented.

In some embodiments, another method may include determining, by a first device including a processor, identity information for a first entity associated with a transaction, wherein the first entity is determined to be associated with a second device; and encrypting credit card information for a second entity with an encryption key uniquely associated with the identity information for the first entity and resulting in secure data. The method may also include transmitting the secure data to the second device for commencement of the transaction.

In yet another embodiment, a computer readable storage device storing executable instructions that, in response to execution, cause a device comprising a processor to perform operations. The operations may include receiving first credit card information in association with an attempted transaction; and determining that the first credit card information is secure data previously generated for another transaction by encrypting second credit card information with an encryption key, wherein the encryption key is associated with an identity of a merchant for the other transaction. The operations may also include generating information indicating that the attempted transaction is fraudulent based on the determining.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, various non-limiting embodiments are further described with reference to the accompanying drawings in which:

FIG. 1 illustrates an example block diagram of a system that may facilitate the use of encryption to provide secure credit card payments in accordance with one or more embodiments described herein;

FIG. 2 illustrates an example block diagram of another system that may facilitate the use of encryption to provide secure credit card payments in accordance with one or more embodiments described herein;

FIG. 3 illustrates an example block diagram of another system that may facilitate the use of encryption to provide secure credit card payments in accordance with one or more embodiments described herein;

FIG. 4 illustrates an example block diagram of another system that may facilitate the use of encryption to provide secure credit card payments in accordance with one or more embodiments described herein;

FIG. 5 illustrates an example block diagram of another system that may facilitate the use of encryption to provide secure credit card payments in accordance with one or more embodiments described herein;

FIG. 6 illustrates an example block diagram of a consumer device of the system of FIGS. 1, 2, 3, 4 and/or 5, which may facilitate the use of encryption to provide secure credit card payments in accordance with one or more embodiments described herein;

FIG. 7 illustrates an example block diagram of a table that may facilitate the use of encryption to provide secure credit card payments in the system of FIGS. 1, 2, 3, 4 and/or 5 in accordance with one or more embodiments described herein;

FIG. 8 illustrates an example block diagram showing an example operation of an encryption component of the consumer device of the system of FIGS. 1, 2, 3, 4, 5 and/or 6, which may facilitate the use of encryption to provide secure credit card payments in accordance with one or more embodiments described herein;

FIG. 9 illustrates an example block diagram of a merchant device of the system of FIGS. 1, 2, 3 and/or 5, which may facilitate the use of encryption to provide secure credit card payments in accordance with one or more embodiments described herein;

FIG. 10 illustrates an example block diagram of an intermediary device of the system of FIG. 3, which may facilitate the use of encryption to provide secure credit card payments in accordance with one or more embodiments described herein;

FIGS. 11-13 illustrate example flowcharts of methods associated with provisioning of secure credit card payments in accordance with one or more embodiments described herein; and

FIG. 14 illustrates an example block diagram of a computing device that is arranged for facilitating the use of encryption to secure credit card payments in accordance with one or more embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, may be arranged, substituted, combined, separated, and designed in a wide variety of different configurations, all of which are explicitly contemplated herein.

One impediment to transactions is the lack of security inherent in providing credit card information to a merchant. Many consumers dislike providing credit card numbers to merchants. Furnishing a credit card number may render a consumer vulnerable to theft through the improper use of the stolen credit card number by the merchant or by an employee of the merchant. The consumer may then incur the inconvenience of needing to secure police reports, waiting for re-issued new credit cards and/or proving that the transactions that result from stolen the credit card number were not authorized.

Yet, a credit card number, along with other details, often needs to be provided to merchants to finalize the transaction. The credit card number and other information are often utilized by merchants to obtain authorization for payment of the products and/or services being purchased. This scenario is pervasive whether a consumer is making a purchase in a restaurant, at a gas station, on the internet or with a street merchant. The risk of credit card number theft exists in each of these scenarios. As such, solutions that provide an opportunity to reduce credit card fraud and/or increase allowance of secure consumer transactions are a gain for consumers, payment processors and merchants alike.

One or more embodiments described herein may advantageously provide a system for improving the likelihood of secure credit card payments. The risk of supplying unencrypted credit card numbers is mitigated. One or more of the embodiments may advantageously be provided without any change to or at the merchant. If the merchant has a merchant device, with the structure and/or functionality described herein, then the operations described herein may be performed via communication between the merchant device and consumer device. If the merchant has no device that can electronically transmit the name/identifier/public key for the merchant to the consumer device (e.g., the merchant is a street vendor in a third-world country), the merchant may still be associated with a name/identifier/private key known to the credit card authority. The consumer may then manually input/key/enter the identifier for the merchant into the consumer device. The manual input from the consumer can also include the actual credit card number associated with the consumer in some cases. The manually input information can be employed by the consumer device to generate a new credit card number based on the encryption of the actual credit card number with a key associated with the identifier for the merchant, and provide the new credit card number to the merchant (or merchant device) to consummate the transaction.

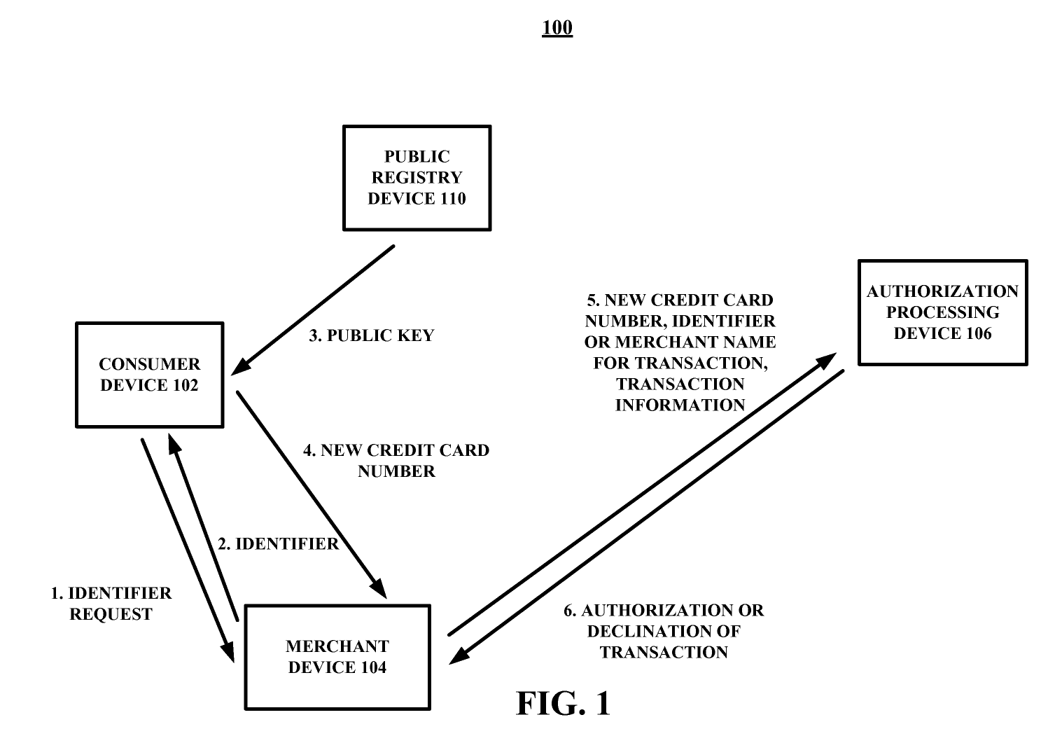

Turning now to the drawings, FIG. 1 illustrates an example block diagram of a system 100 that may facilitate the use of encryption to provide secure credit card payments in accordance with one or more embodiments described herein. In the embodiment shown, system 100 includes a consumer device 102, a merchant device 104 and an authorization processing device 106. In various embodiments, one or more of the consumer device 102, merchant device 104 and/or authorization processing device 106 may be electrically and/or communicatively coupled to one another to perform one or more functions of system 100. In some embodiments, as shown, system 100 may also include a public registry device 110 that may be communicatively coupled to and accessible by consumer device 102 and, in some embodiments, is provided by an authorization entity associated with authorization processing device 106. For example, consumer device 102 can communicate with public registry device 110 to obtain the public key. By way of example, but not limitation, consumer device 102 can request the specific public key associated with merchant device 104 and obtain such public key for further use by consumer device 102.

Consumer device 102 may be any number of different types of devices that have the structure and/or functionality to communicate with merchant device 104 and/or another device in systems 200, 300, 400, and 500 further described below and encrypt an actual credit card number for a user or owner of consumer device 102 with an identifier and/or key (e.g., public key) for a merchant with which the owner or user of consumer device 102 seeks to consummate a transaction. By way of example, but not limitation, consumer device 102 may be or include a smart phone, a laptop, or any type of device that may perform one or more of the functions of consumer device 102. By way of example, but not limitation, consumer device 102 can be or include a smart credit card having a microprocessor that can facilitate communication with merchant device 104 (e.g., via placement of consumer device 102 within a defined distance of merchant device 104), facilitate encryption functionality regarding the owner of the smart credit card and/or associated account, store identification information for the owner of the smart credit card, track participation in loyalty programs or provide any number of other functions. In some embodiments, consumer device 102 may be configured to connect to and communicate with any one of merchant device 104, public registry device 110 and/or authorization processing device 106 directly via electrical, wired or wireless connection and/or over a network. By way of example, but not limitation, any number of methods for communicating over a wired or a wireless connection can be employed in the embodiments described herein, and can employ any number of vehicles for transfer of information. For example, in some embodiments, the communication can be via cellular or other wireless or wired communication between merchant device 104 and consumer device 102, via electronic mail between merchant device 104 and consumer device 102 and/or via a connection between merchant device 104 and consumer device 102 based on or in response to touching the consumer device 102 and merchant device 104 to one another.

In system 100, consumer device 102 transmits an electronic request to merchant device 104 for an identifier of the merchant associated with merchant device 104. The identifier may be any number of different types of information that uniquely identifies the merchant. By way of example, but not limitation, the identifier may be a name of the merchant, an identification number associated with the merchant, a business license for the merchant or the like.

Merchant device 104 may be a device (e.g., credit card device) that includes structure and/or functionality to communicate information over a wired or wireless connection to consumer device 102 and/or authorization processing device 106. Merchant device 104 receives the electronic request from consumer device 102 and transmits, over a wired or wireless channel, electronic information indicative of the identifier for the merchant associated with merchant device 104 to consumer device 102. In various embodiments, the identifier is an identifier that authorization processing device 106 would recognize as being associated with the merchant.

Upon receipt of the identifier for the merchant, consumer device 102 may encrypt an actual credit card number associated with an owner or user of consumer device 102 with a public key uniquely associated with the identifier received via merchant device 104. In another embodiment, consumer device 102 may encrypt an actual credit card number associated with an owner or user of consumer device 102 with the identifier associated with the merchant.

By way of example, but not limitation, as shown, consumer device 102 may obtain the key from public registry device 110, which accesses electronic information indicative of a repository of public keys associated with identifiers for various different merchants. For example, the repository may be published by credit card or other payment authorization entities that have established relationships with the merchants and would therefore know the public key for the merchant (along with the private key for the merchant, which authorization processing device 106 associated with the authorization entity may then use to decrypt a new credit card information generated by consumer device 102).

In some embodiments, consumer device 102 generates a new credit card number by encrypting the actual credit card number with the public key (or, in other embodiments, by encrypting the actual credit card number with an identifier for the merchant provided by merchant device 104). In various embodiments, consumer device 102 may perform encryption based on any number of different approaches, including symmetric and/or asymmetric approaches. In various embodiments, the encryption performed by consumer device 102 may include, but is not limited to, algorithms described at http://csrc.nist.gov/groups/ST/toolkit/block_ciphers.html (e.g., Advanced Encryption Standard (AES) (e.g., AES-AllSizes, AES-128, AES-192, AES-256), Triple Data Encryption Algorithm, Escrowed Encryption Standard, Secure Hash Algorithm (SHA)), Data Encryption Standard (DES) described at http://www.eecs.berkeley.edu/˜messer/netappc/Supplements/13-encalgs.pdf, stream cipher algorithms and/or the RC4 stream encryption algorithm described at http://cse.spsu.edu/afaruque/it6833/RC4.pdf or the like.

In some embodiments, consumer device 102 may employ public key encryption to encrypt the credit card number. As used herein, public key encryption refers to an asymmetric cryptography process by which two separate keys (e.g., one secret/private key and one public key) are employed for cryptography. For example, consumer device 102 may first encrypt the actual credit card number employing symmetric encryption using the key associated with the identifier of the merchant. For example, consumer device 102 may include one or more stream cipher devices and/or block cipher devices configured to encrypt the credit card number digits. The resultant encrypted set of numbers may then be further encrypted with the credit card public key.

In some embodiments, with symmetric encryption, the key that is used by consumer device 102 to perform the encryption may be the same key employed by authorization processing device 106 to decrypt the new credit card number and retrieve the actual credit card number to determine if the transaction should be approved. In various embodiments, the key is uniquely dictated by the identifier for the merchant and the credit card processing company (or authorization processing device 106) knows the private key in advance of the transaction. Therefore, authorization processing device 106 is aware of the private key for the particular merchant upon receipt of the electronic signal from the merchant indicating the name or identifier for the merchant. In some embodiments, to maintain security of the new credit card number, by avoiding decryption of such number by merchant device 104, the private key (e.g., the decryption key), which is employed by authorization processing device 106 to perform decryption, is inaccessible and unknown to merchant device 104 and/or to the merchant.

Merchant device 104 transmits to authorization processing device 106 the new credit card information provided by consumer device 102 and, in some embodiments, also transmits information identifying the merchant to the credit card processing company so that authorization processing device 106 may employ the correct key for decrypting the new credit card number received by merchant device 104.

In some embodiments, the key that authorization processing device 106 employs to perform the decryption may be a transformed version of the key that consumer device 102 employed to perform the encryption to generate the new credit card number. For example, the key employed by authorization processing device 106 may be the private key associated with the public key employed by consumer device 102 to perform the encryption generating the new credit card number.

The result of the encryption is a new credit card number that may or may not have the same number of digits as the actual credit card number. In any case, the new credit card number provided has no ties to the account associated with the actual credit card number and, as such, the merchant is unable to utilize the new credit card number for any future transactions. As a result, the user or owner of consumer device 102 is able to maintain secrecy of the actual credit card number associated with the user or owner while providing information to the merchant that may be employed to facilitate the transaction.

As used herein, the term “credit card number” also includes debit card number or any other account number associated with a source of monetary funds. As such, in some embodiments, in which a transaction may be facilitated by providing a checking or savings account number from which funds for a transfer may be accessed, consumer device 102 may encrypt the account number or other information for the bank account as well. Variously, any number of different types of information may be encrypted with an identifier for a merchant or a key associated with the identifier for the merchant to generate a new credit card/debit card/bank account number for use by merchant device 104.

In some embodiments, in addition to encrypting the credit card number, consumer device 102 may also encrypt date/time information for the transaction and/or a transaction value (e.g., price or fee being paid for the good or service provided by the merchant) for the transaction.

Merchant device 104 may then transmit an electronic signal to authorization processing device 106 that includes information indicative of the new credit card number (that is the result of the encryption) that was transmitted to merchant device 104 by consumer device. In this case, the encrypted information may also include the transaction date/time/value or other information in addition to the new credit card number.

Authorization processing device 106 may decrypt the new credit card number and validate the payment for the transaction. For example, authorization processing device 106 may first decrypt the new credit card number with the electronic private key stored at or accessible by authorization processing device 106. Authorization processing device 106 may then further decrypt the result of the first decryption by applying the symmetric key for the merchant. The number has no use to anyone else as it may only show that the owner or user of consumer device 102 paid a particular merchant at a particular time.

In some embodiments, authorization processing device 106 may decrypt the new credit card number (or new credit card information and transaction information) with the private key corresponding to the merchant identifier. The result of the decryption may be the actual credit card number (or the actual credit card number concatenated with transaction information).

Accordingly, authorization processing device 106 may decrypt the new credit card number because authorization processing device 106 knows the encryption scheme and the key for the merchant, which is associated with the identifier for the merchant. The rest of the process for authorization at authorization processing device 106 is performed as if an unencrypted credit card number was sent to authorization processing device 106.

If the payment is authorized, authorization processing device 106 may transmit an electronic signal via wired or wireless communication channel to merchant device 104 indicating that the transaction should be approved. Similarly, if the payment is not authorized, authorization processing device 106 may transmit an electronic signal via wired or wireless communication channel to merchant device 104 indicating that the transaction should not be approved.

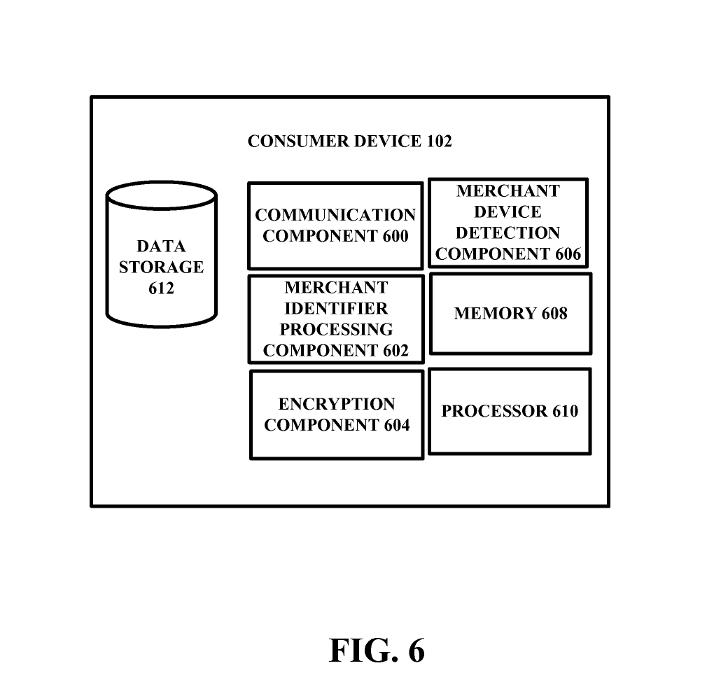

One example scenario includes consumer device 102 being employed to purchase a cruise ship ticket from a merchant having an identifier “Travel-AAA.” Credit card number 123456789 is stored in consumer device 102 as electronic data and consumer device 102 includes processors and/or an encryption component (e.g., an encryption component 604 described with reference to FIG. 6) that allow consumer device 102 to encrypt electronic data indicative of 123456789 with electronic data indicative of identifier “Travel-AAA” (or allowing consumer device to encrypt electronic data indicative of 123456789 with electronic information indicative of a public key that corresponds to “Travel-AAA.”

In another embodiment, consumer device 102 may also include the time of the request made by consumer device 102 for the identifier and/or the time for the transaction and/or the time of receipt of the identifier and/or the amount of the transaction or any other information associated with the transaction in the encryption.

The result of the encryption of 123456789 may be 1223-4334-5786-7954 (credit cards tend to have 16 digits, but that may depend on the type of credit card and 16 digits need not be the length of the new credit card number). Further, as described, in some embodiments, a checking or savings account number may be encrypted and a new checking or savings account number may be provided. As such, in various embodiments, the new number generated by encryption may be the same or a different number of digits as the actual number. Accordingly, in various embodiments, the actual credit card number is distinct from the new credit card number.

Merchant device 104 may receive an electronic signal indicative of this new credit card number from consumer device 102. Merchant device 104 may transmit the new credit card number over wired channel or wireless channel to authorization processing device 106. Authorization processing device 106 may decrypt 1223-4334-5786-7954 with the key uniquely associated with “Travel-AAA” to generate 123456789. Authorization processing device 106 employs the true credit card number 123456789 in verifying and authorizing (or declining) the transaction payment. In some embodiments, authorization processing device 106 may transmit electronic information indicative of authorization, declination and/or a payment to merchant device 104 and/or to a bank associated with merchant device 104.

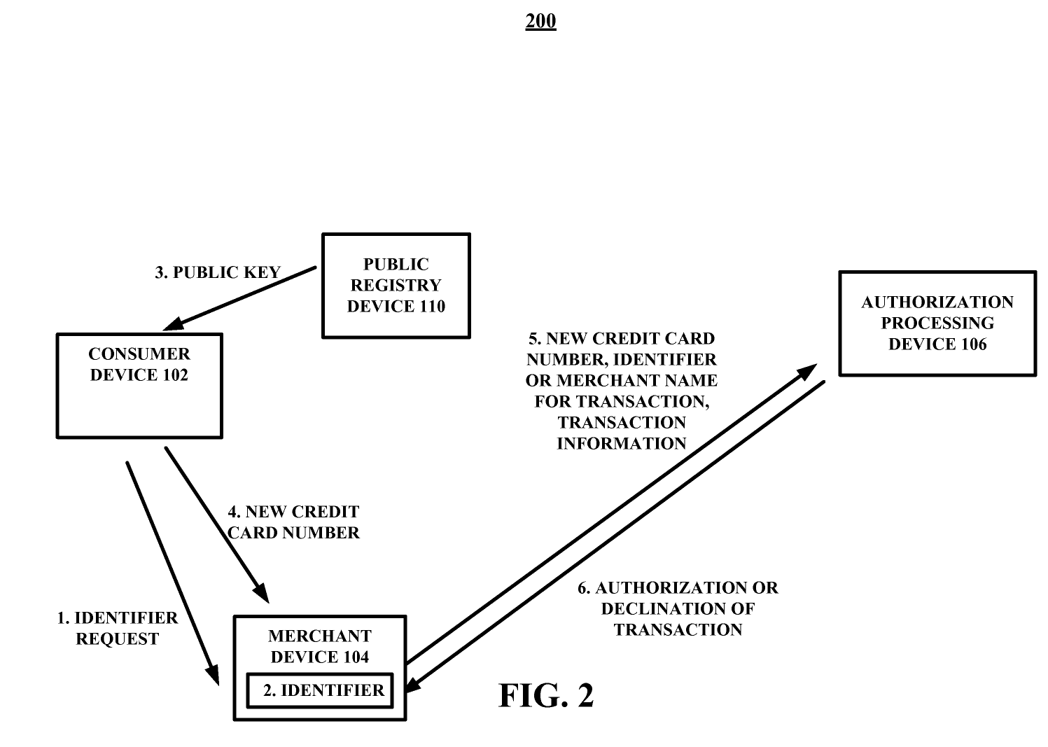

FIG. 2 illustrates an example block diagram of another system 200 that may facilitate the use of encryption to provide secure credit card payments in accordance with one or more embodiments described herein. Repetitive description of like elements employed in respective embodiments of systems and/or apparatus described herein are omitted for sake of brevity.

In system 200, consumer device 102 may communicate with merchant device 104 by generating an electronic request for an identifier for the merchant associated with merchant device 104. In some embodiments, the request is transmitted in response to consumer device 102 detecting the presence of merchant device 104 and/or in response to merchant device 104 detecting the presence of consumer device 102 (e.g., by a physical credit card being swiped at merchant device 104). For example, consumer device 102 may be a smart phone that may be shaken to awaken and detect merchant device 104 and/or activate communication with merchant device 104.

Merchant device 104 generates an electronic display of an identifier of the merchant. A user of consumer device 102 may enter the identifier at consumer device 102 via an input/output (I/O) device of consumer device 102. Consumer device 102 may obtain a public key for the identifier and/or encrypt the actual credit card number for the owner or user of consumer device 102 with the identifier (or public key corresponding to the identifier). Consumer device 102 may transmit the new credit card number to merchant device 104. Merchant device 104 then verifies that the transaction may be performed by transmitting transaction information, merchant name or identifier and/or new credit card number to authorization processing device 106. At no time is merchant device 104 aware of the actual credit card number.

In some embodiments, the merchant identifier may be provided to a user or owner of consumer device 102 verbally (e.g., by a street vendor in a third-world country) and consumer device 102 may receive a manual entry of the identifier via an input/output (I/O) device (not shown) (e.g., keyboard, touch screen graphical user interface) of consumer device 102. Consumer device 102 may obtain a public key for the identifier and/or encrypt the actual credit card number for the owner or user of consumer device 102 with the identifier (or public key corresponding to the identifier). Consumer device 102 may transmit the new credit card number to merchant device 104. Merchant device 104 then verifies that the transaction may be performed by transmitting transaction information, merchant name or identifier and/or new credit card number to authorization processing device 106. At no time is merchant device 104 aware of the actual credit card number.

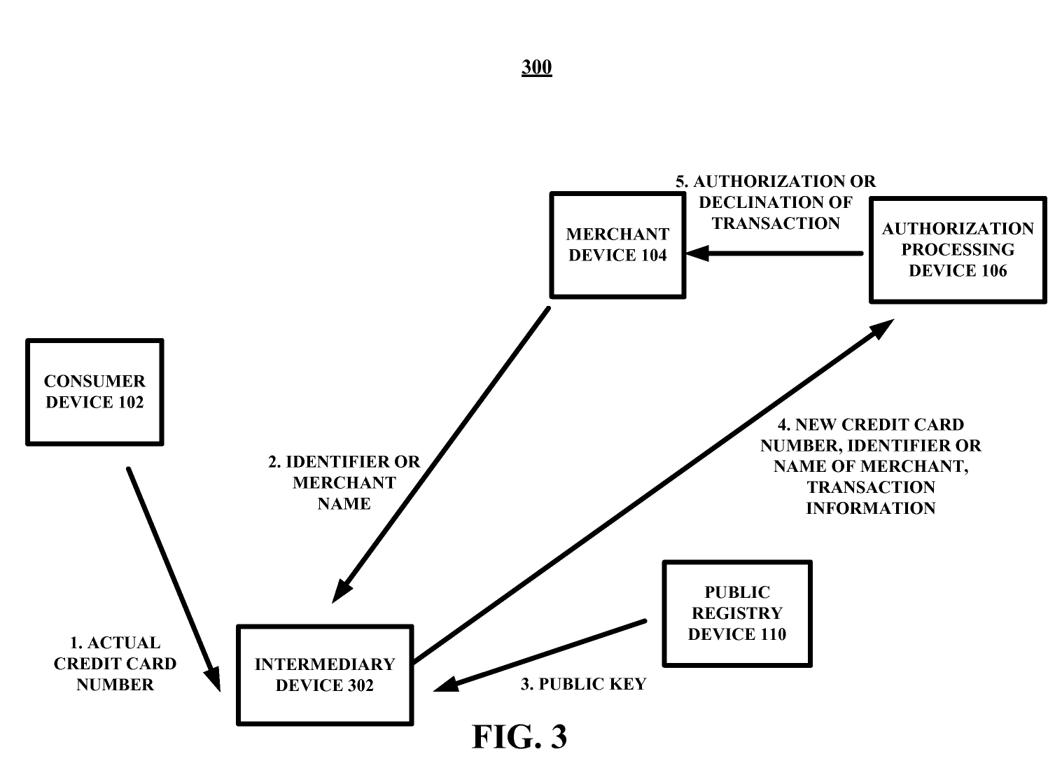

FIG. 3 illustrates an example block diagram of another system 300 that may facilitate the use of encryption to provide secure credit card payments in accordance with one or more embodiments described herein. Repetitive description of like elements employed in respective embodiments of systems and/or apparatus described herein are omitted for sake of brevity.

In system 300, an intermediary device 302 receives first electronic information indicative of the actual credit card number associated with a user or owner of consumer device 102. For example, the first electronic information is received over a wired or wireless channel from consumer device 102. Intermediary device 302 also receives second electronic information indicative of the identifier associated with a merchant associated with merchant device 104. For example, the second electronic information is received over a wired or wireless channel from merchant device 104. Merchant device 104 may also include details regarding the transaction to be verified (e.g., transaction amount).

As another example, the second electronic information indicative of the identifier associated with the merchant may be stored at or retrieved by intermediary device 302 over a network. For example, in this embodiment, the first electronic information indicative of the actual credit card number may also include an identifier of a name of a merchant. Intermediary device may then obtain the identifier for the merchant.

In either embodiment, intermediary device 302 may encrypt the first electronic information indicative of the actual credit card number and transmit the new credit card number along with the merchant identifier to authorization processing device 106 for verification of the transaction. In various embodiments, authorization processing device 106 may transmit authorization/declination of the transaction to merchant device 104 and/or to intermediary device 302 (which may relay the authorization/declination to merchant device 104 and/or consumer device 102).

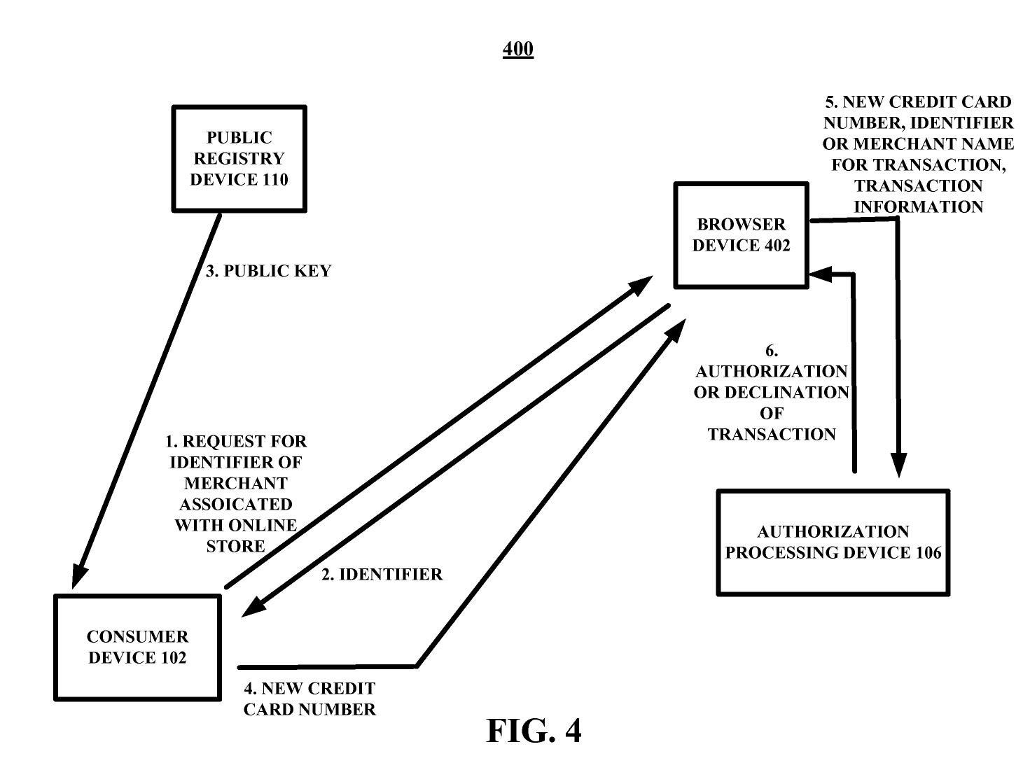

FIG. 4 illustrates an example block diagram of another system 400 that may facilitate the use of encryption to provide secure credit card payments in accordance with one or more embodiments described herein. Repetitive description of like elements employed in respective embodiments of systems and/or apparatus described herein are omitted for sake of brevity.

In one embodiment of system 400, consumer device 102 may contact a browser device 402 that serves webpages at which online store purchases may be made upon consumer device connecting to the webpage over the internet. The webpage may be associated with a particular merchant. In one embodiment, consumer device 102 may request the identifier for the webpage from browser device 402. Upon receipt of the identifier from browser device 402, consumer device 102 may obtain a public key from public registry device 110 and encrypt the actual credit card number associated with an owner or user of consumer device 102. Consumer device 102 may transmit the new credit card information over the network to browser device 402 to initiate the transaction of the products/services advertised via the webpage.

In another embodiment of system 400, consumer device 102 may browse to a webpage associated with a merchant. Upon consumer device 102 transmitting a request to initiate a purchase of a good/service advertised on the webpage, browser device 402 may encrypt the actual credit card number provided via consumer device 102 based on the knowledge of the identifier of the merchant by browser device 402. Browser device 402 may then transmit the new credit card information over the network to a device processing the transactions for the merchant for which the online webpage is provided. For example, browser device 402 may access the public key associated with the identifier of the merchant and use the same for the encryption of the actual credit card number.

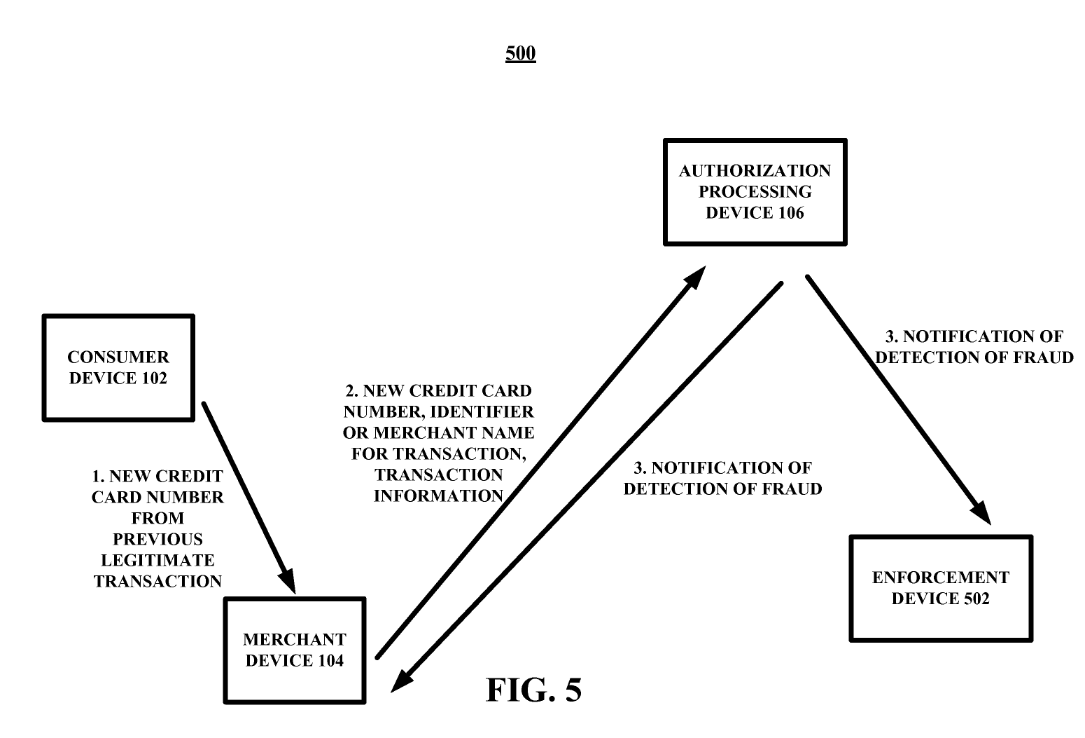

FIG. 5 illustrates an example block diagram of another system 500 that may facilitate the use of encryption to provide secure credit card payments in accordance with one or more embodiments described herein. Repetitive description of like elements employed in respective embodiments of systems and/or apparatus described herein are omitted for sake of brevity.

In system 500, the encryption procedure employed herein may also facilitate the detection of fraud. For example, a third-party may intercept a new credit card number while the new credit card number is being transmitted by consumer device 102 to merchant device (or being transmitted from merchant device 104 to authorization processing device 106) or at a location of a merchant at which the new credit card number was provided for a prior transaction. The third-party may attempt to re-use the new credit card number at a later time with the same merchant or at any time with a different merchant, authorization processing device 106. Upon receipt of the new credit card number, authorization processing device 106 may process the attempted transaction and generate information identifying this use as an attempt at fraud (and/or decline the transaction).

For example, authorization processing device 106 may receive the new credit card number from a first merchant while the new credit card number was encrypted with a public key or an identifier associated with a second merchant that differs from the first merchant. As such, authorization processing device 106 will apply the private key associated with the second merchant and will be unable to access the actual credit card number. This scenarios allows authorization processing device 106 to detect fraudulent representation of a new credit card number whenever the second merchant (i.e., the merchant for the prior legitimate transaction) differs from the first merchant (i.e., the merchant to whom the new credit card number is being fraudulently presented).

As another example, authorization processing device 106 may receive the new credit card number that is a result of encrypting the actual credit card number with transaction information (e.g., date/time/amount of the transaction) from a first merchant while the new credit card number was encrypted with a public key or an identifier associated with a second merchant that differs from the first merchant. As such, authorization processing device 106 will apply the private key associated with the second merchant and will be unable to access the actual credit card number. This scenarios allows authorization processing device 106 to detect fraudulent representation of a new credit card number whenever the second merchant (i.e., the merchant for the prior legitimate transaction) differs from the first merchant (i.e., the merchant to whom the new credit card number is being fraudulently presented).

As another example, authorization processing device 106 may receive the new credit card number that is a result of encrypting the actual credit card number with transaction information (e.g., date/time/amount of the transaction) from a first merchant, and the first merchant is the same merchant with which the prior legitimate transaction was conducted. Authorization processing device 106 will apply the private key for the merchant and successfully decrypt the new credit card number. However, the result will be the actual credit card number but transaction information that fails to match date/time/amount of the legitimate, prior transaction. This scenarios allows authorization processing device 106 to detect fraudulent representation of a new credit card number whenever the transaction details differ from those of the legitimate transaction details (even if the merchant is the same across both transactions).

Authorization processing device 106 may generate a signal reporting the attempted fraud and/or transmit a signal to the merchant device indicating that the use is an attempt at fraud. The signal may be transmitted to an enforcement device 502 and/or to merchant device 104 in various embodiments. In some embodiments, enforcement device 502 may be a device that receives the signal from authorization processing device 106 indicating attempted fraud and generate one or more signals to cause particular actions to be taken. Enforcement device 502 can be located at or associated with a law enforcement agency in some embodiments. For example, enforcement device 502 can generate one or more additional signals that are received at the law enforcement agency notifying the agency of the details (e.g., location, amount of the attempted fraud).

While particular flows of information are shown in systems 100, 200, 300, 400, 500, in various embodiments, other information can also be exchanged within systems 100, 200, 300, 400, 500 to facilitate the functions of systems 100, 200, 300, 400, 500 but may not be shown for simplicity and brevity. By way of example, but not limitation, in various embodiments, consumer device 102 can request a public key from public key registry device 110 and any number of other requests, handshaking operations or other exchange of information can also be performed in systems 100, 200, 300, 400, 500 according to the general functionality of systems 100, 200, 300, 400, 500 described herein. All embodiments and variations are envisaged.

FIG. 6 illustrates an example block diagram of consumer device 102 of the system of FIGS. 1, 2, 3, 4 and/or 5, which may facilitate the use of encryption to provide secure credit card payments in accordance with one or more embodiments described herein. Repetitive description of like elements employed in respective embodiments of systems and/or apparatus described herein are omitted for sake of brevity.

Consumer device 102 may include a communication component 600, a merchant identifier processing component 602, an encryption component 604, a merchant device detection component 606, a memory 608, a processor 610 and/or a data storage 612. In various embodiments, one or more of communication component 600, merchant identifier processing component 602, encryption component 604, merchant device detection component 606, memory 608, processor 610 and/or data storage 612 may be electrically and/or communicatively coupled to one another to perform one or more functions of consumer device 102.

Communication component 600 may transmit and/or receive information from and/or to consumer device 102. For example, the information transmitted may be or include audio, video, text, images, animation or any other information indicative of a request for an identifier of a merchant with which a user or owner of consumer device 102 is attempting to perform a transaction. In some embodiments, communication component 600 may also transmit and/or receive information indicative of a request for a key associated with the identifier for the merchant, the key associated with the identifier, transaction time, date and/or amount or the like.

In one embodiment, communication component 600 transmits, to merchant device 104, an electronic request for an identifier for a merchant associated with merchant device 104, and receives electronic information indicative of the identifier. Communication component 600 may transmit a request from a registry for a public key associated with the identifier and/or receive information indicative of the public key.

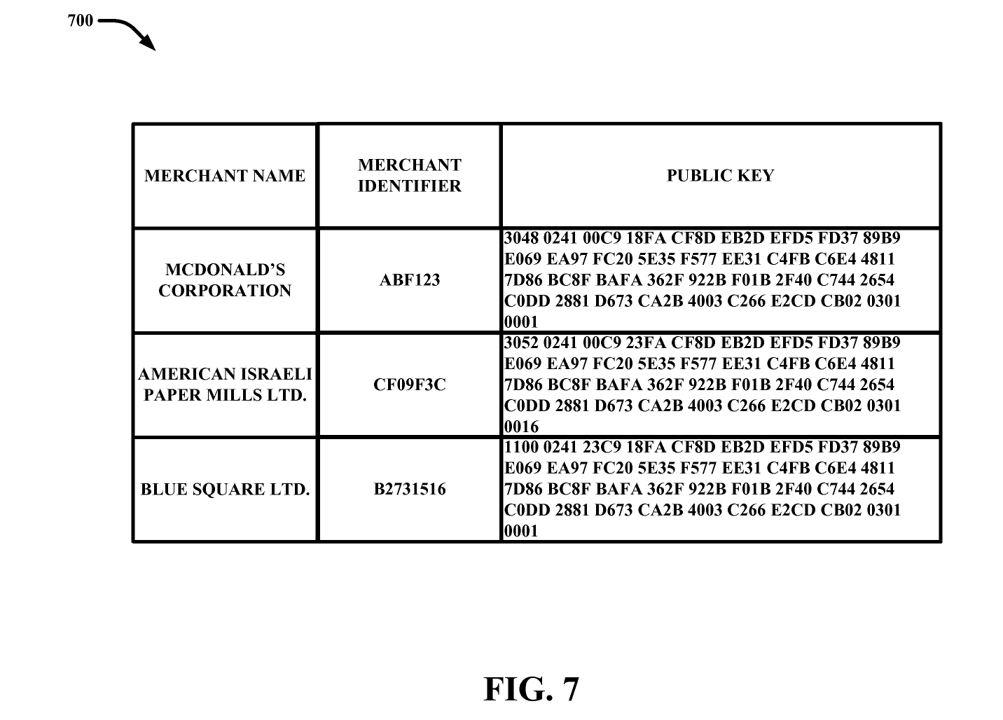

FIG. 7 illustrates an example block diagram of information of a public registry 700 that may facilitate the use of encryption to provide secure credit card payments in the system of FIGS. 1, 2, 3, 4 and/or 5 in accordance with one or more embodiments described herein. Repetitive description of like elements employed in respective embodiments of systems and/or apparatus described herein are omitted for sake of brevity.

Shown in FIG. 7 is an example of a portion of public registry 700 from which consumer device 102 may access and/or request the public key corresponding to the identifier for the merchant. In some embodiments, public registry 700 may be published by an authorization entity (e.g., a credit card company) that has an account with the various merchants for whom public keys are listed. As shown in FIG. 7, in public registry 700, each identifier for a merchant is associated with a public key. Communication component 600 of consumer device 102 may use the identifier provided by merchant device 104 to identify the public key corresponding to the identifier. Communication component 600 may retrieve the public key for the identifier.

Turning back to FIG. 6, merchant identifier processing component 602 may process the identifier received from merchant device 104 and/or process a key (e.g., public key of FIG. 7) associated with the identifier. For example, merchant identifier processing component 602 may format a key or the identifier to enable use of the identifier and/or key for encryption (e.g., by encryption component 604) with the credit card number.

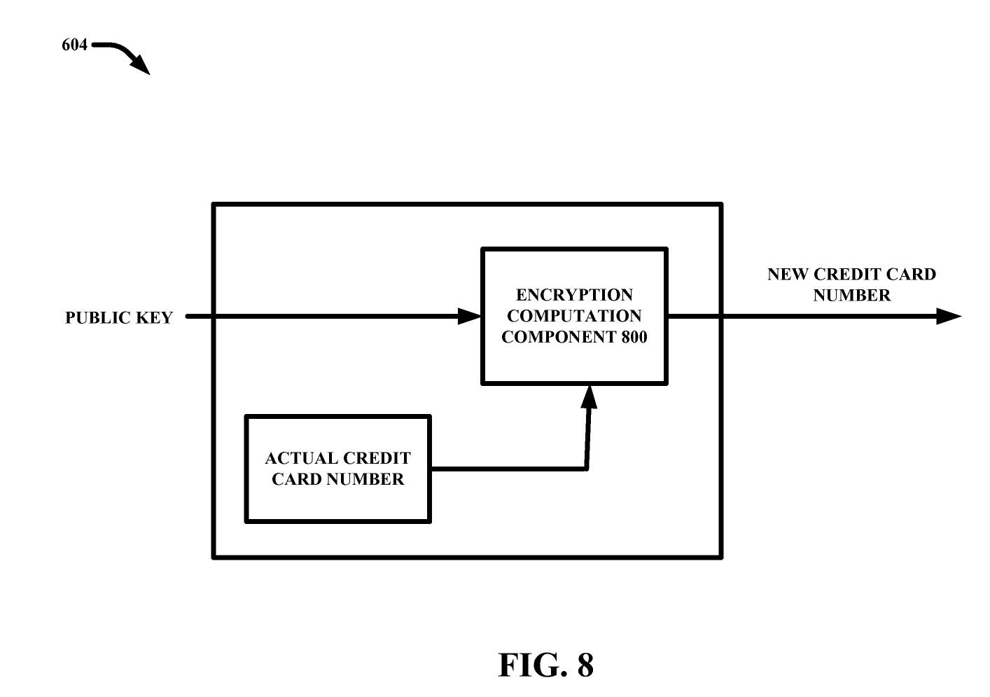

FIG. 8 illustrates an example block diagram showing an example operation of an encryption component 604 of consumer device 102 of the system of FIGS. 1, 2, 3, 4, 5 and/or 6, which may facilitate the use of encryption to provide secure credit card payments in accordance with one or more embodiments described herein. Repetitive description of like elements employed in respective embodiments of systems and/or apparatus described herein are omitted for sake of brevity.

As shown in FIG. 8, encryption component 604 may encrypt the actual credit card number for consumer device 102 to generate a new credit card number. Communication component 600 may then transmit the new credit card number to merchant device 104 in some embodiments of systems described herein. In other embodiments, communication component 600 may transmit the new credit card number to any number of different components to facilitate the transaction while mitigating risk of theft of the actual credit card number. All such embodiments are envisaged herein.

In various embodiments, encryption component 604 encrypts the credit card number with the identifier of the merchant or with the public key associated with the identifier of merchant. By way of example, but not limitation, the public key is a key made available to/accessible by consumer device 102 in a publicly accessible electronic database (e.g., public registry 700 of FIG. 7). For example, communication component 600 may access an online electronic database to obtain the public key for a particular identifier of a merchant with which the owner or user of consumer device 102 seeks to commence a transaction. Although not shown, in some embodiments, encryption component 604 may also include a key stream generator that may receive the public key, generate a pseudorandom byte (or pseudorandom number, generally) and output the pseudorandom number to an encryption computation component 800 along with the actual credit card number for encryption of the actual credit card number with the pseudorandom number.

With reference to FIGS. 1 and 8, for example, since authorization processing device 106 has access to the secret private key associated with the merchant, and the public key that encryption component 604 employs to encrypt the actual credit card number is mathematically related to the private key, authorization processing device 106 may decrypt the new credit card number upon receipt from merchant device 104 and access the actual credit card number.

Turning back to FIG. 6, merchant device detection component 606 may detect the presence of merchant device 104 in some embodiments. Merchant device detection component 606 may initiate or participate in communications (via communication component 600) with merchant device 104 upon detection of merchant device 104 in some embodiments. For example, consumer device 102 may be a smart phone or other device that, when shaken or otherwise activated, may awaken and initiate a communication process with merchant device 104.

In another embodiment, encryption component 604 may utilize a public key associated with a particular authorization entity that authorizes transactions for a particular merchant. Communication component 600 may receive the identifier of a merchant from merchant device 104. Encryption component 604 may concatenate the identifier (or name) for the merchant and the actual credit card number for a user or owner associated with consumer device 102 to create a string composed of the merchant identifier (or name) and the credit card number. Encryption component 604 may encrypt the string of information with the public key for the authorization entity and communication component 600 may transmit the encrypted information to merchant device 104. Merchant device 104 may transmit the encrypted information to authorization processing device 106. Authorization processing device 106 may decrypt the encrypted information employing the private key for the authorization entity and validate that consumer device 102 provided the string to merchant device 104. Because the string includes the identifier for the merchant, which may be known to authorization processing device 106, authorization processing device 106 may identify the portion of the string that is the actual credit card number.

Memory 608 may be a computer-readable storage medium storing computer-executable instructions and/or information for performing the functions described herein with reference to consumer device 102 (or any component of consumer device 102). For example, memory 608 may store computer-executable instructions that may be executed by processor 610 to receive the identifier for the merchant associated with consumer device 102, obtain a public key associated with the identifier, detect the presence of merchant device 104, perform encryption of the actual credit card number to generate a new credit card number and/or any other functions described with reference to consumer device 102. Processor 610 may perform one or more of the functions described herein with reference to consumer device 102 (or any component of consumer device 102) including, but not limited to, receipt of the identifier for the merchant associated with consumer device 102, obtaining of a public key associated with the identifier, detection of the presence of merchant device 104, performance of encryption of the actual credit card number to generate a new credit card number and/or any other functions described with reference to consumer device 102. Data storage 612 may be configured to store information accessed by, received by and/or processed by consumer device 102 (or any component of consumer device 102) including, but not limited to, identifier for the merchant associated with merchant device 104, actual credit card number, new credit card number generated after encryption of the actual credit card number, transaction date and/or time, transaction amount or the like.

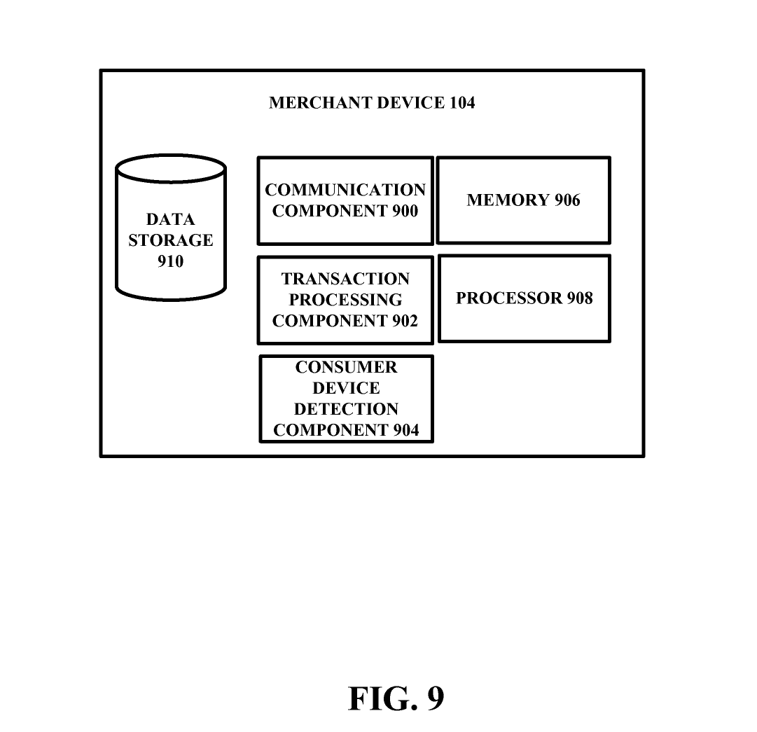

FIG. 9 illustrates an example block diagram of merchant device 104 of the system of FIGS. 1, 2, 3 and/or 5, which may facilitate the use of encryption to provide secure credit card payments in accordance with one or more embodiments described herein. Repetitive description of like elements employed in respective embodiments of systems and/or apparatus described herein are omitted for sake of brevity.

Merchant device 104 may include a communication component 900, a transaction processing component 902, a consumer device detection component 904, a memory 906, a processor 908 and/or a data storage 910. In various embodiments, one or more of communication component 900, transaction processing component 902, consumer device detection component 904, memory 906, processor 908 and/or data storage 910 may be electrically and/or communicatively coupled to one another to perform one or more functions of merchant device 104.

Communication component 900 may transmit and/or receive information indicative of an identifier for the merchant associated with merchant device 104. For example, communication component 900 may transmit the information to consumer device 102. Communication component 900 may receive information such as the new credit card number encrypted by consumer device 102.

Transaction processing component 902 may transmit and/or receive transaction information. For example, the transaction information may be transmitted to and/or from authorization processing device 106. The transaction information may include, but is not limited to, the new credit card number received from consumer device 102 and, in some embodiments, time, date and/or amount of the transaction. Transaction processing component 902 may receive information indicative of an authorization or denial of the transaction from authorization processing device 106.

Consumer device detection component 904 may detect the presence of consumer device 102 in some embodiments. Consumer device detection component 904 may initiate or participate in communications with consumer device 102 upon detection of consumer device 102 in some embodiments. For example, consumer device 102 may be a smart phone or other device that, when shaken or otherwise activated, may be detected by consumer device detection component 904 and communication component 900 may then initiate a communication process with consumer device 102.

Memory 906 may be a computer-readable storage medium storing computer-executable instructions and/or information for performing the functions described herein with reference to merchant device 104 (or any component of merchant device 104). For example, memory 906 may store computer-executable instructions that may be executed by processor 908 to communicate the identifier for the merchant associated with merchant device 104 to consumer device 102 and/or any other entities to which the identifier may be communicated (e.g., authorization processing device 106 or intermediary device 302), detect the presence of consumer device 102, receipt of authorization or declination regarding transaction, perform payment processing for authorized transactions or any other functions of merchant device 104. Processor 908 may perform one or more of the functions described herein with reference to merchant device 104 (or any component of merchant device 104) including, but not limited to, communication of the identifier for the merchant associated with merchant device 104 to consumer device 102 and/or any other entities to which the identifier may be communicated (e.g., authorization processing device 106 or intermediary device 302), detection of the presence of consumer device 102, receipt of authorization or declination regarding transaction, payment processing for authorized transactions or any other functions of merchant device 104. Data storage 910 may be configured to store information accessed by, received by and/or processed by merchant device 104 (or any component of merchant device 104) including, but not limited to, identifier for the merchant associated with merchant device 104, new credit card number provided by consumer device 102 after encryption of the actual credit card number, transaction date and/or time, transaction amount or the like.

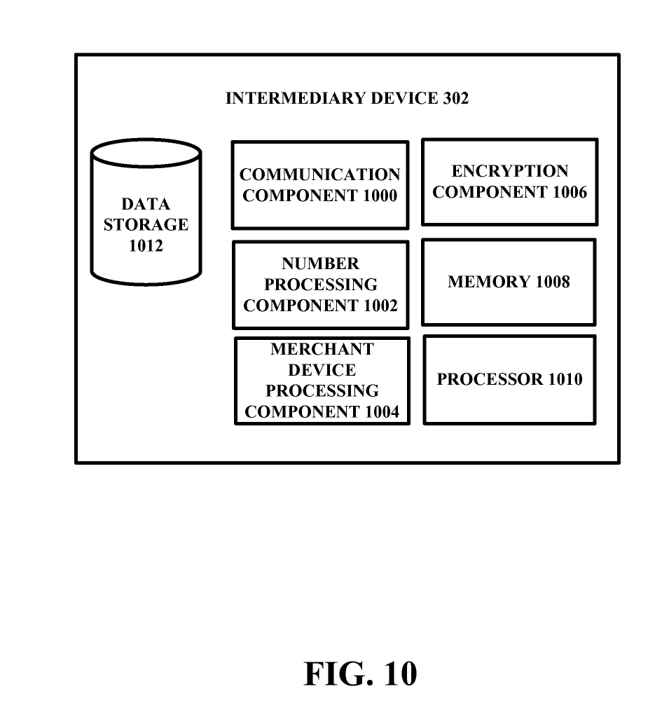

FIG. 10 illustrates an example block diagram of intermediary device 302 of system 300 of FIG. 3, which may facilitate the use of encryption to provide secure credit card payments in accordance with one or more embodiments described herein. Repetitive description of like elements employed in respective embodiments of systems and/or apparatus described herein are omitted for sake of brevity.

Intermediary device 302 may include a communication component 1000, a number processing component 1002, a merchant device processing component 1004, an encryption component 1006, a memory 1008, a processor 1010 and/or a data storage 1012. In various embodiments, one or more of communication component 1000, number processing component 1002, merchant device processing component 1004, encryption component 1006, memory 1008, processor 1010 and/or data storage 1012 may be electrically and/or communicatively coupled to one another to perform one or more functions of intermediary device 302.

Communication component 1000 may transmit and/or receive information about a merchant and/or about a credit card number for an owner or user of a consumer device for facilitating a transaction. By way of example, but not limitation, electronic data such as the actual credit card number offered for a transaction from an owner or user associated with consumer device 102 may be received at communication component 1000 over wired or wireless channels from consumer device 102. In some embodiments, electronic data indicative of a name or identifier for a merchant with which consumer device 102 is attempting to have a transaction may be received by communication component 1000. In some embodiments, communication component of intermediary device 302 may access the name and/or identifier for the merchant without receiving such information and based solely on information that consumer device 102 may provide to communication component 1000 of intermediary device 302 about the transaction.

Number processing component 1002 may receive and/or process the actual credit card number for the owner or user of consumer device 102. Merchant device processing component 1004 may receive and/or process an identifier for a merchant, a name for a merchant, transaction time, date and/or amount details or the like.

Encryption component 1006 may employ a public key to encrypt a credit card number provided by consumer device 102. For example, in one embodiment, encryption component 1006 may determine the public key associated with an identifier for the merchant for which merchant device processing component 1004 has received a name or identifier by searching a public registry of identifiers and corresponding public keys. Encryption component 1006 may then encrypt the actual credit card number with the public key to generate a new credit card number associated with the owner or user of consumer device 102.

In some embodiments, encryption component 1006 may concatenate the identifier (or name) for the merchant with the actual credit card number for a user or owner associated with consumer device 102 to create a string composed of the merchant identifier (or name) and the credit card number. Encryption component 1006 may encrypt the string of information with the public key for the authorization entity and communication component 1000 may transmit the encrypted information to authorization processing device 106. Authorization processing device 106 may decrypt the encrypted information employing the private key for the authorization entity and determine whether to approve or decline the transaction.

In some embodiments, communication component 1000 may transmit the new credit card number along with the identifier for (or other information identifying) the merchant to authorization processing device 106. Authorization processing device 106 may determine whether to approve or decline the transaction and/or may transmit to merchant device 104, and/or intermediary device 302, information indicative of whether the transaction is approved or declined.

Memory 1008 may be a computer-readable storage medium storing computer-executable instructions and/or information for performing the functions described herein with reference to intermediary device 302 (or any component of intermediary device 302). For example, memory 1008 may store computer-executable instructions that may be executed by processor 1010 to perform encryption of actual credit card numbers associated with owners or users of consumer devices, transmission of new credit card numbers to authorization entities or any other functions of intermediary device 302. Processor 1010 may perform one or more of the functions described herein with reference to intermediary device 302 (or any component of intermediary device 302) including, but not limited to, encryption of actual credit card numbers associated with owners or users of consumer devices, receipt or determination of identifiers for merchants, transmission of new credit card numbers to authorization entities or any other functions of intermediary device 302. Data storage 1012 may be configured to store information accessed by, received by and/or processed by intermediary device 302 (or any component of intermediary device 302) including, but not limited to, identifiers of merchants, credit card numbers of owners or users of consumer devices, new credit card numbers, transaction date and/or time, transaction amount or the like.

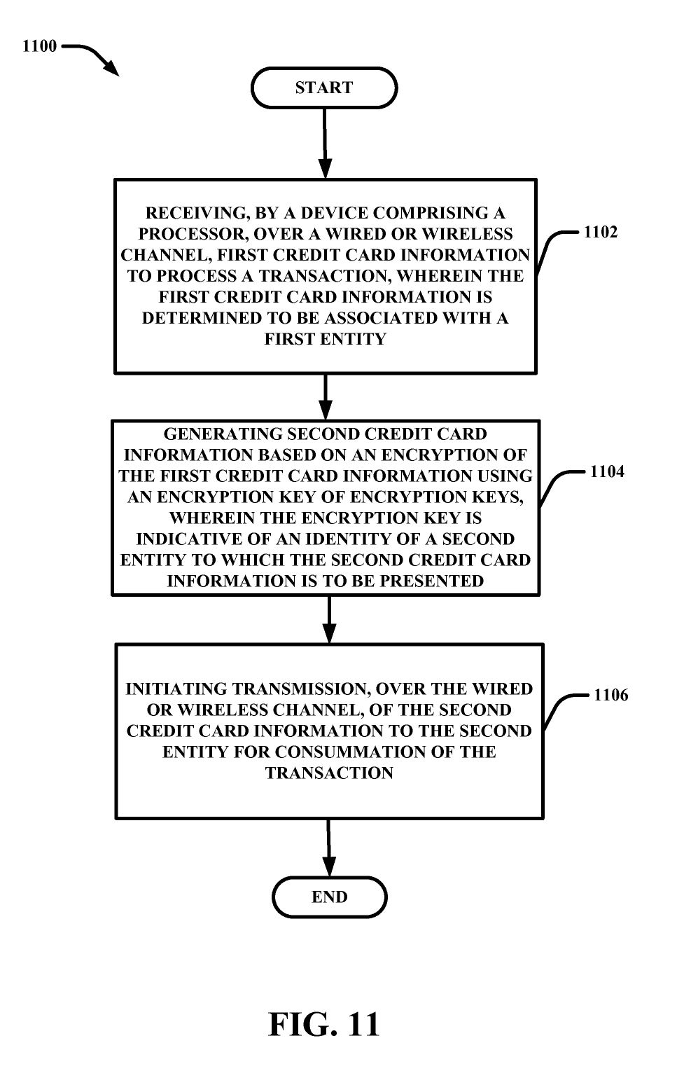

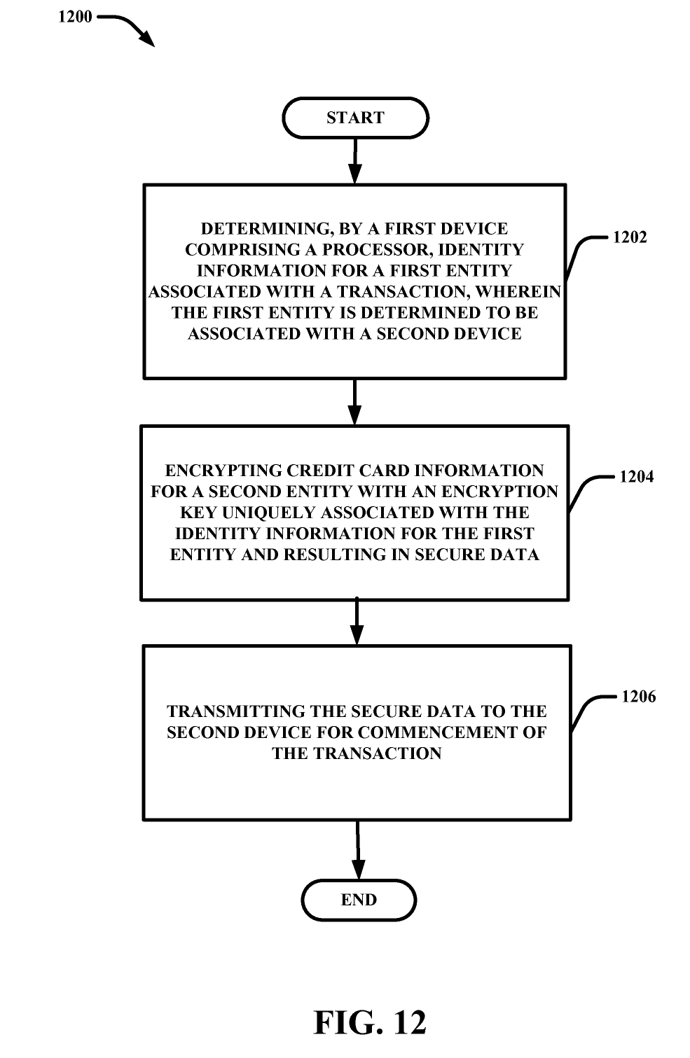

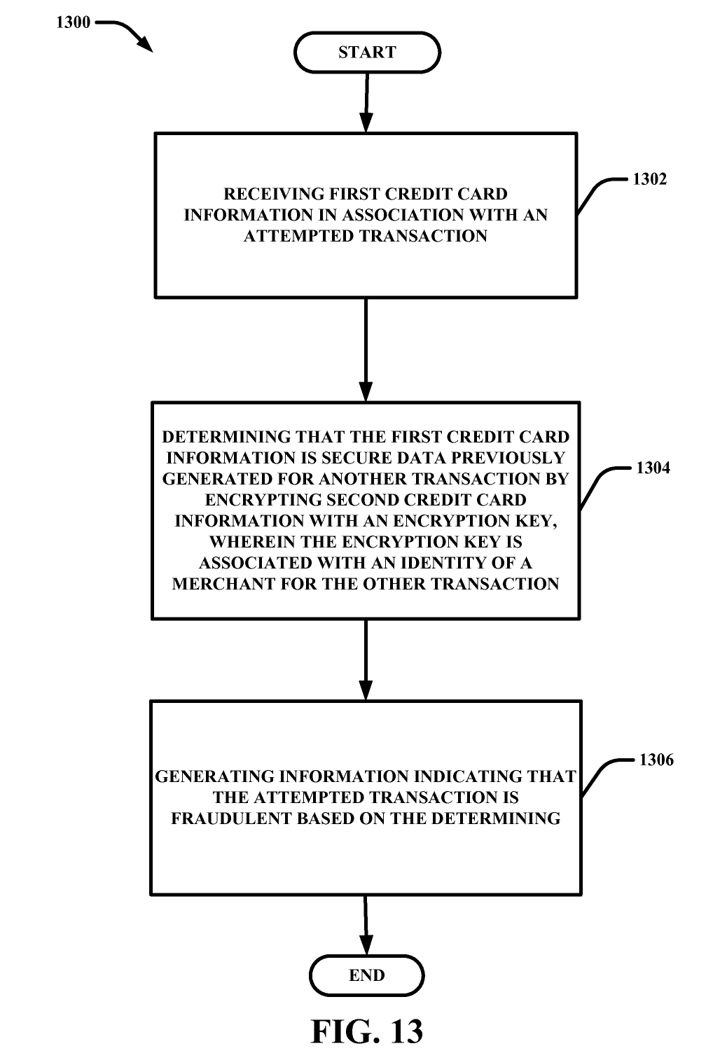

FIGS. 11-13 illustrate example flowcharts of methods associated with facilitating the use of encryption to secure credit card payments in accordance with one or more embodiments described herein. FIG. 11 illustrates a method 1100 that may include one or more operations, functions or actions as illustrated by one or more of blocks 1102, 1104, and/or 1106. FIG. 12 illustrates a method 1200 that may include one or more operations, functions or actions as illustrated by one or more of blocks 1202, 1204, and/or 1206. FIG. 13 illustrates a method 1300 that may include one or more operations, functions or actions as illustrated by one or more of blocks 1302, 1304, and/or 1306. The operations, functions or actions illustrated in each of methods 1100, 1200, or 1300 may in some embodiments be performed by a system such as the systems of FIGS. 1, 2, 3, 4 and/or 5.

Turning first to FIG. 11, at block 1102, method 1100 may include receiving, by a device (e.g., consumer device) including a processor, over a wired or wireless channel, first credit card information to process a transaction, wherein the first credit card information is determined to be associated with a first entity (e.g., merchant). Block 1102 may be followed by block 1104.

At block 1104, method 1100 may include generating second credit card information based on an encryption of the first credit card information using an encryption key of encryption keys, wherein the encryption key is indicative of an identity of a second entity to which the second credit card information is to be presented. For example, the encryption key is a public key exclusively associated with the identity of the second entity. A decryption key may be employed for decryption of the second credit card information by a device (e.g., authorization processing device) associated with an authorization entity. For example, the decryption key may be a private key mathematically related to the public key and known to the device associated with the authorization entity.

In some embodiments, the length of the first credit card information is different than the second credit card information, wherein the first credit card information comprises a first number of characters and the second credit card information comprises a second number of characters, and wherein the first number of characters is different than the second number of characters. The lengths may be the same or different in various different embodiments. Block 1104 may be followed by block 1106.

At block 1106, method 1100 may include initiating transmission, over the wired or wireless channel, of the second credit card information to the second entity for consummation of the transaction. In some embodiments, the transmission of the second credit card information is directed to another device, associated with an authorization entity, for decryption of the second credit card information by the other device and a determination of the first credit card information as a result of the decryption.

In some embodiments, although not shown, method 1100 may include generating additional information based on another encryption, using the encryption key indicative of the identity of the second entity, of at least one of received time information associated with the transaction, or a received transaction amount associated with the transaction.

In some embodiments, although not shown, method 1100 may include receiving identity data representing the identity of the second entity.

Turning now to FIG. 12, at block 1202, method 1200 may include determining, by a first device including a processor, identity information for a first entity associated with a transaction, wherein the first entity is determined to be associated with a second device. Block 1202 may be followed by block 1204. At block 1204, method 1200 may include encrypting credit card information for a second entity with an encryption key uniquely associated with the identity information for the first entity and resulting in secure data. Block 1204 may be followed by block 1206.

At block 1206, method 1200 may include transmitting the secure data to the second device for commencement of the transaction. In some embodiments, the first device and the second device are communicatively coupled during the determining. In some embodiments, the secure data is directed to an address associated with a device of an authorization entity for decryption of the secure data by the device of the authorization entity using a decryption key to determine the credit card information. For example, the encryption key is a public key and the decryption key is a private key.

Although not shown, in some embodiments, method 1200 may include transmitting, to the second device, a request for the identity information for the first entity.

Turning now to FIG. 13, at block 1302, method 1300 may include receiving (e.g., by authorization processing device from a merchant device) first credit card information in association with an attempted transaction. The first credit card information may be an encrypted, new credit card number received at an authorization processing entity from a merchant device that has been presented with the new credit card number. In some embodiments, the receiving comprises receiving the first credit card information via at least one of an electrical signal between the device (e.g., authorization processing entity) and another device (a merchant device). Block 1302 may be followed by block 1304.

At block 1304, method 1300 may include determining (e.g., by authorization processing device 106) that the first credit card information is secure data previously generated for another transaction by encrypting second credit card information with an encryption key, wherein the encryption key is associated with an identity of a merchant for the other transaction. The second credit card number is the actual credit card number that belongs to a different user from the user presenting the first credit card number during attempted fraud. Block 1304 may be followed by block 1306.

At block 1306, method 1300 may include generating information indicating that the attempted transaction is fraudulent based on the determining. The authorization processing device may generate an alert or information that is transmitted to an enforcement body or the merchant. In some embodiments, the method may include transmitting the information to another device (e.g., merchant device presenting the first credit card number or an enforcement body associated with fraud detection). In some embodiments, the method may also include, based on the information indicating the attempted transaction is fraudulent, rejecting the attempted transaction.

In various embodiments described herein, numerous operations may be performed only by computers. These operations include, but are not limited to, performing encryption employing the detailed and complex operations of encryption operations, transmitting and/or receiving over a wired channel or a wireless channel electronic data or signals that travel though electrical wires or wireless channels (e.g., wireless signals transmitted and/or received via wireless channels between consumer device 102, merchant device 104, intermediary device 302, browser device 402 and/or authorization processing device 106), modulation and/or demodulation of signals received and/or transmitted and the like Humans are incapable of practicing all of the operations of the various claimed embodiments, and therefore, ipso facto, the various embodiments cannot be mere implementations of well-known or fundamental economic or human behavior. The claims do not simply recite a fundamental economic practice, a method of organizing human activities, an idea of itself, or a mathematical relationship/formula.

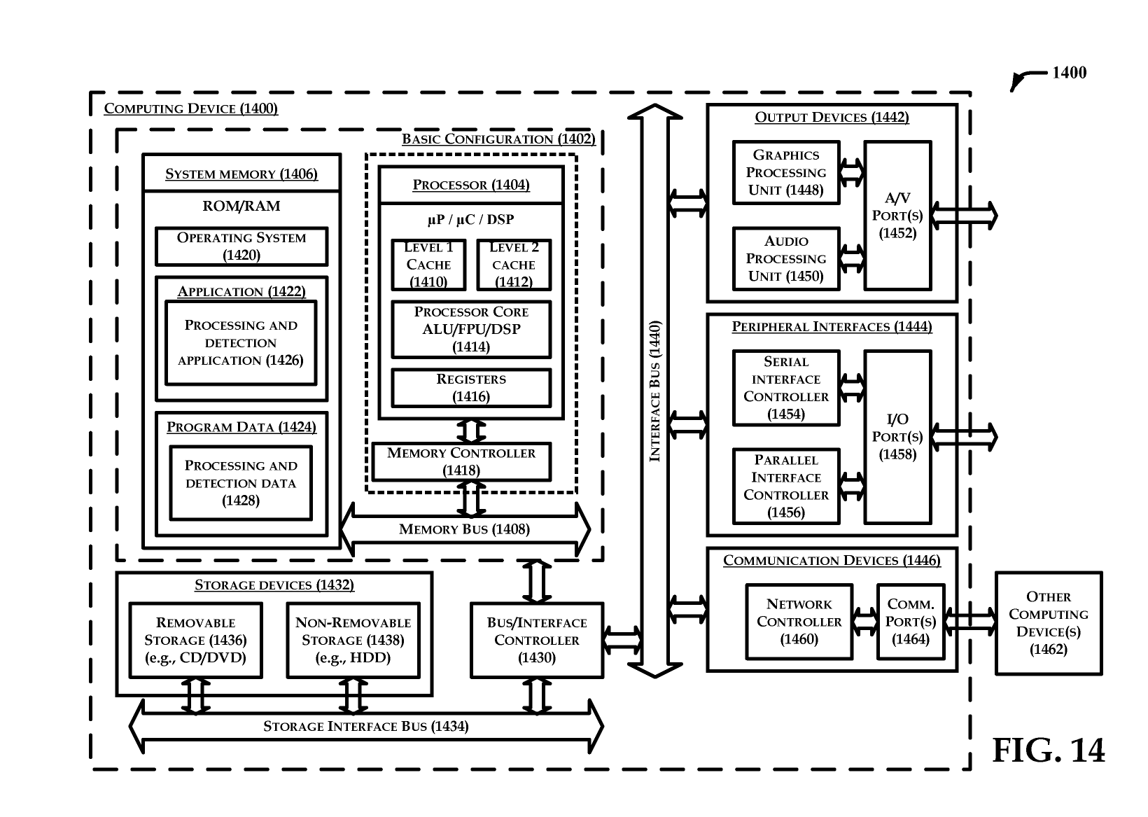

FIG. 14 illustrates an example block diagram of a computing device 1400 that is arranged for facilitating the use of encryption to secure credit card payments in accordance with one or more embodiments described herein. In a very basic configuration 1402, computing device 1400 typically includes one or more processors 1404 and a system memory 1406. In some embodiments, system memory 1406 may be or include consumer device 102, merchant device 104, authorization processing device 106, browser device 402 and/or intermediary device 302 (or any components of consumer device 102, merchant device 104, authorization processing device 106, browser device 402 and/or intermediary device 302). In some embodiments, computing device 1400 may be included in consumer device 102, merchant device 104, authorization processing device 106, browser device 402 and/or intermediary device 302 (or any components of consumer device 102, merchant device 104, authorization processing device 106, browser device 402 and/or intermediary device 302). A memory bus 1408 may be used for communicating between a processor 1404 and system memory 1406.

Depending on the desired configuration, processor 1404 may be of any type including but not limited to a microprocessor (μP), a microcontroller (μC), a digital signal processor (DSP), or any combination thereof. Processor 1404 may include one more levels of caching, such as a level one cache 1410 and a level two cache 1412, a processor core 1414, and registers 1416. An example processor core 1414 may include an arithmetic logic unit (ALU), a floating point unit (FPU), a DSP core, or any combination thereof. An example memory controller 1418 may also be used with processor 1404, or in some implementations a memory controller 1418 may be an internal part of processor 1404.

Depending on the desired configuration, system memory 1406 may be of any type including but not limited to volatile memory (such as RAM), non-volatile memory (such as ROM, flash memory, etc.) or any combination thereof. System memory 1406 may include an operating system 1420, one or more applications 1422 (e.g., a processing and detection application 1426), and program data 1424 (e.g., processing and detection data 1428). In some embodiments, one or more applications 1422 may be arranged to operate with program data 1424 on operating system 1420 such that the use of encryption to provide secure credit card payments may be performed as described herein. This described basic configuration 1402 is illustrated in FIG. 14 by those components within the inner dashed line.

Computing device 1400 may have additional features or functionality, and additional interfaces to facilitate communications between basic configuration 1402 and any required devices and interfaces. For example, a bus/interface controller 1430 may be used to facilitate communications between basic configuration 1402 and one or more data storage devices 1432 via a storage interface bus 1434. Data storage devices 1432 may be removable storage devices 1436, non-removable storage devices 1438, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 1406, removable storage devices 1436 and non-removable storage devices 1438 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 1400. Any such computer storage media may be part of computing device 1400.

Computing device 1400 may also include an interface bus 1440 for facilitating communication from various interface devices (e.g., output devices 1442, peripheral interfaces 1444, and communication devices 1446) to basic configuration 1402 via bus/interface controller 1430. In some embodiments, although not shown, computing device 1400 can include interfaces that are common to, but not limited to, personal computers or smart phone models. In some embodiments, the interface can include, but are not limited to, a BLUETOOTH® interface, a near field communication interface and/or a wireless fidelity (Wi-Fi) interface. In this regard, computing device 1400 can communicate with a device external to computing device 1400 (e.g., consumer device 102 and merchant device 104 can communicate with one another) via any number of various communication protocols.

Example output devices 1442 include a graphics processing unit 1448 and an audio processing unit 1450, which may be configured to communicate to various external devices such as a display or speakers via one or more A/V ports 1452. Example peripheral interfaces 1444 include a serial interface controller 1454 or a parallel interface controller 1456, which may be configured to communicate with external devices such as input devices (e.g., keyboard, mouse, pen, voice input device, touch input device, etc.) or other peripheral devices (e.g., printer, scanner, etc.) via one or more I/O ports 1458. An example communication device 1446 includes a network controller 1460, which may be arranged to facilitate communications with one or more other computing devices 1462 over a network communication link via one or more communication ports 1464.

Computing device 1400 may be implemented as a portion of a small-form factor portable (or mobile) electronic device such as a cell phone, smart credit cards, a personal data assistant (PDA), a personal media player device, a wireless web-watch device, a personal headset device, an application specific device, or a hybrid device that include any of the above functions. Computing device 1400 may also be implemented as a personal computer including both laptop computer and non-laptop computer configurations.

A network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The use of hardware or software may be generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system can be implemented utilizing any suitable commercially available components, such as those typically found in data computing/communication and/or network computing/communication systems.

The herein described subject matter sometimes illustrates different components contained within, or connected with, different other components. Such depicted architectures are merely examples, and many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described in this application, which are intended as illustrations of various aspects. Many modifications and variations can be made without departing from its spirit and scope. Functionally equivalent methods and devices within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, computer-readable storage devices, systems or apparatus disclosed, which can, of course, vary. The terminology used herein is for the purpose of describing particular embodiments only, and is not intended to be limiting.

What is claimed is:

1. A method, comprising:
receiving, by a device comprising a processor, over a wired or wireless channel, first credit card information to process a transaction, wherein the first credit card information is determined to be associated with a first entity; and
generating second credit card information based on an encryption of the first credit card information using an encryption key of encryption keys, wherein the encryption key is indicative of an identity of a second entity to which the second credit card information is to be presented.

2. The method of claim 1, further comprising:
initiating transmission, over the wired or wireless channel, of the second credit card information to the second entity for consummation of the transaction.

3. The method of claim 2, wherein the transmission of the second credit card information is directed to another device, associated with an authorization entity, for a decryption of the second credit card information by the other device and a determination of the first credit card information as a result of the decryption.

4. The method of claim 1, wherein the encryption key is a public key generated to be exclusively associated with the identity of the second entity.

5. The method of claim 4, wherein a decryption key, used for a decryption of the second credit card information by another device associated with an authorization entity and that is accessible to the other device, is a private key inaccessible to the second entity.

6. The method of claim 1, further comprising:
generating additional information based on another encryption, using the encryption key indicative of the identity of the second entity, of at least one of received time information associated with the transaction, or a received transaction amount associated with the transaction.

7. The method of claim 1, wherein the first credit card information is different than the second credit card information, wherein the first credit card information comprises a first number of characters and the second credit card information comprises a second number of characters, and wherein the first number of characters is different than the second number of characters.

8. The method of claim 1, wherein the first credit card information is different than the second credit card information, wherein the first credit card information comprises a first number of characters and the second credit card information comprises a second number of characters, and wherein the first number of characters equals the second number of characters.

9. The method of claim 1, further comprising:
receiving, over the wired channel or the wireless channel, identity data representing the identity of the second entity.

10. A method, comprising:
determining, by a first device comprising a processor, identity information for a first entity associated with a transaction, wherein the first entity is determined to be associated with a second device;
encrypting credit card information for a second entity with an encryption key uniquely associated with the identity information for the first entity and resulting in secure data; and
transmitting the secure data to the second device for commencement of the transaction.

11. The method of claim 10, wherein the first device and the second device are communicatively coupled during the determining, and the method further comprises:
transmitting, to the second device, over the wired channel or the wireless channel, a request for the identity information for the first entity.

12. The method of claim 10, wherein the secure data is directed to an address associated with a device of an authorization entity for decryption of the secure data by the device of the authorization entity using a decryption key to determine the credit card information.

13. The method of claim 12, wherein the encryption key is a public key and the decryption key is a private key.

14. A computer readable storage device storing executable instructions that, in response to execution, cause a device comprising a processor to perform operations, comprising:
receiving first credit card information in association with an attempted transaction;
determining that the first credit card information is secure data previously generated for another transaction by encrypting second credit card information with an encryption key, wherein the encryption key is associated with an identity of a merchant for the other transaction; and
generating information indicating that the attempted transaction is fraudulent based on the determining.

15. The computer readable storage device of claim 14, wherein the operations further comprise:
transmitting the information to another device associated with fraud detection.

16. The computer readable storage device of claim 14, wherein the operations further comprise:
based on the information indicating the attempted transaction is fraudulent, rejecting the attempted transaction.

17. The computer readable storage device of claim 14, wherein the secure data was further previously generated by encrypting time information regarding the other transaction with the encryption key.

18. The computer readable storage device of claim 14, wherein the first credit card information is distinct from the second credit card information, wherein the first credit card information has a first number of characters and the second credit card information has a second number of characters, and the first number of characters is different from the second number of characters.

19. The computer readable storage device of claim 14, wherein the first credit card information is distinct from the second credit card information, and wherein the first credit card information has a first number of characters and the second credit card information has a second number of characters equal to the first number of characters.

20. The computer readable storage device of claim 14, wherein the receiving comprises receiving the first credit card information via at least one of an electrical signal between the device and another device, or a manual input received by the device.
